(19) United States
(12) Patent Application Publication
(10) Pub. No.: US 2021/0141355 A1
(43) Pub. Date: May 13, 2021

(54) SYSTEMS AND METHODS OF AUTONOMOUS LINE FLOW CONTROL IN ELECTRIC POWER SYSTEMS

(71) Applicants: Global Energy Interconnection Research Institute Co. Ltd, Beijing (CN); State Grid Corporation of China Co. Ltd, Beijing (CN); State Grid Jiangsu Electric Power Co., LTD., Nanjing (CN); State Grid ShanXi Electric Power Company, Jinan (CN)

(72) Inventors: Jiajun Duan, San Jose, CA (US); Bei Zhang, San Jose, CA (US); Di Shi, San Jose, CA (US); Ruisheng Diao, San Jose, CA (US); Xiaohu Zhang, San Jose, CA (US)

(21) Appl. No.: 17/091,917

(22) Filed: Nov. 6, 2020

Related U.S. Application Data
(60) Provisional application No. 62/932,398, filed on Nov. 7, 2019.

(51) Int. Cl. G05B 19/042; G06N 3/08

(52) U.S. Cl. CPC G05B 19/042; G05B 2219/24215; G05B 2219/2639; G06N 3/08

(57) ABSTRACT

Systems and methods for autonomous line flow control in an electric power system are disclosed which includes acquiring state information at a line in the electric power system at a first time step, obtaining a flow data of the line at a next time step based on the acquired state information, generating an early warning signal when the obtained flow data is higher than a predetermined threshold, activating a deep reinforcement learning (DRL) agent to generate an action using a DRL algorithm based on the state information, and executing the action to adjust a topology of the electric power system.

### CROSS-REFERENCE TO RELATED APPLICATIONS

This application claims priority to U.S. Provisional Application No. 62/932,398 filed on 7 Nov. 2019 and entitled “An Approach for Line Flow Control via Topology Adjustment,” and is herein incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in drawings that form a part of this document: Copyright, GEIRI North America, All Rights Reserved.

### FIELD OF TECHNOLOGY

The present disclosure generally relates to electric power transmission and distribution system, and, more particularly, to systems and methods of autonomous line flow control in electric power systems.

### BACKGROUND OF TECHNOLOGY

Maximizing available transfer capabilities (ATCs) is of critical importance to bulk power systems from both security and economic perspectives, which represents the remaining transfer margin of transmission network for further energy transactions. Due to environmental and economic concerns, transmission expansion via building new lines for enlarging transfer capabilities is no longer an easy option for many utilities across the world. Additionally, the increasing penetration of renewable energy, demand response, electric vehicles, and power-electronics equipment has caused more stochastic and dynamic behavior that threatens safe operation of the modern power grid. Thus, it becomes essential to develop fast and effective control strategies for maximizing ATCs considering uncertainties while satisfying various security constraints which may apply when, for example, transmission assets are expected to be operated beyond rated short-term capability after any defined contingent event. Security constraints may be applied as a temporary constraint to deal with an outage situation when some assets are not available; or a permanent constraint when a normal integrated power system capability and expected generation offers and demand may not result in secure operation.

Compared with re-dispatching generators, shedding electricity demands, and installing flexible alternating current transmission system (FACTS) devices, active network topology control via transmission line switching or bus splitting for increasing ATCs and mitigating congestions provides a low-cost and effective solution, especially for a deregulated power market or utilities with limited choices (e.g., RTE France with nuclear power supplying vast majority of its demands). This idea was first proposed in the early 1980s when several research efforts were conducted for achieving multiple control purposes such as cost minimization, voltage, and line flow regulation. H. Glavitsch, “Switching as means of control in the power system,” International Journal of Electrical Power & Energy Systems, vol. 7, no. 2, pp. 92-100, 1985, and A. A. Mazi, B. F. Wollenberg, M. H. Hesse, “Corrective control of power system flows by line and bus-bar switching,” IEEE trans. Power Syst., vol. 1, no. 3, pp. 258-264, 1986. Transmission line switching or bus splitting/rejoining is essentially a multivariate discrete programming problem that is difficult to solve, given the complexity and uncertainties of bulk power systems. Various approaches have been reported to tackle this problem. In E. B. Fisher, R. P. O'Neill, M. C. Ferris, “Optimal transmission switching,” IEEE trans. Power Syst., vol. 23, no. 3, pp. 1346-1355, 2008, a mixed-integer linear programming (MIP) model is proposed with DC power flow approximation of the power network, where a generalized optimization solver, CPLEX from IBM, is adopted to solve the MIP. In A. Khodaei, and M. Shahidehpour, “Transmission switching in security-constrained unit commitment,” IEEE trans. Power Syst., vol. 25, no. 4, pp. 1937-1945, 2010, the transmission switching (TS) optimization process with DCOPF is decoupled from a master unit commitment procedure, where the optimal TS schedule is formulated as a MW problem that is again solved using CPLEX. Another reference, J. D. Fuller, R. Ramasra, and A. Cha, “Fast heuristics for transmission-line switching,” IEEE Trans. Power Syst., vol. 27, no. 3, pp. 1377-1386, 2012, presents a fast heuristic method to speed up the convergence using the aforementioned modeling and solution practice. Similar approaches with variations are also reported in P. Dehghanian, Y. Wang, G. Gurrala, et al., “Flexible implementation of power system corrective topology control,” Electric Power Syst. Research, vol. 128, pp. 79-89, 2015, and M. Alhazmi, P. Dehghanian, S. Wang, et al., “Power grid optimal topology control considering correlations of system uncertainties,” IEEE Tran. Ind Appl., Early Access, 2019, which use a point estimation method for modeling system uncertainties with AC power flow feasibility checking and correction modules.

However, several limitations are observed in existing methods. One of the limitations is that the linear approximation in DC power flow without considering all security constraints is typically utilized, which affects the solution accuracy for a real-world power grid. Using full AC power flow with all security constraints for optimization becomes non-convex due to the high nonlinear nature of power grids, which cannot be effectively solved using state-of-the-art techniques without relaxing/sacrificing certain security constraints or solution accuracy. Another limitation is that the combination set of lines and bus-bars to be switched simultaneously grows exponentially. In addition, sensitivity-based methods are susceptible to changing system operating conditions. Thus, it may take a long time to solve such an optimization process for a large power grid, preventing the solution from being deployed in the real-time environment.

As such, what is desired is fast and autonomous topology control systems and methods for maximizing time-series ATCs in a large-scale electric power system.

### SUMMARY OF DESCRIBED SUBJECT MATTER

The presently disclosed embodiments relate to systems and methods for autonomous line flow control via topology adjustment in electric power systems.

In some embodiments, the present disclosure provides an exemplary technically improved computer-based autonomous line flow control system and method that include acquiring state information at a line in the electric power system at a first time step, obtaining a flow data of the line at a next time step based on the acquired state information, generating an early warning signal when the obtained flow data is higher than a predetermined threshold, activating a deep reinforcement learning (DRL) agent to generate an action using a DRL algorithm based on the state information, and executing the action to control a topology of the electric power system.

In some embodiments, the present disclosure provides an exemplary technically improved computer-based autonomous line flow control system and method that further include activating a deep reinforcement learning (DRL) agent to simulate a predetermined number of top-scored actions based on the state information, selecting an action with the highest simulated score using a DRL algorithm for the execution.

In some embodiments, the present disclosure provides an exemplary technically improved computer-based autonomous line flow control system and method that further include training the DRL agent using a dueling deep Q network (DDQN) prior to controlling the line flow in the electric power system. The DRL agent training includes providing initial weights to the DRL agent with an imitation learning process. The imitation learning process includes generating massive data sets from a virtual environment by a power grid simulator, training the DRL agent using mini-batch data from the data sets with an imitation learning method. The DRL agent training further includes initializing the DRL agent with initial weights, loading time-sequential training data for a predetermined period, generating a suggested action for a zone when an early warning signal for the zone is generated, executing the suggested action in a power grid simulator, evaluating effectiveness of the suggested action with a predefined reward function, restoring transition information from the DRL agent training into a replay buffer of the DRL agent, updating the DRL agent by sampling from the replay buffer after a training episode, recording current episode composition information, and outputting a trained DRL model after a predetermined number of episodes are finished.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIGS. 1-9B show one or more schematic flow diagrams, certain computer-based architectures, and/or computer-generated plots which are illustrative of some exemplary aspects of at least some embodiments of the present disclosure.

FIG. 1 shows a system architecture of training DRL agents for maximizing ATCs according to an embodiment of the present disclosure.

FIG. 2 illustrates an architecture of the dueling DQN agent shown in FIG. 1.

FIG. 3 shows a flowchart of the imitation learning shown in FIG. 1.

FIG. 4 shows a workflow of the early warning system shown in FIG. 1.

FIG. 5 shows a flowchart of an exemplary process for maximizing time-series ATCs according to an embodiment of the present disclosure.

FIG. 6 shows a flowchart of a DRL training process.

FIG. 7 illustrates an electric power system having an AI-based autonomous topology control according to an embodiment of the present disclosure.

FIG. 8 shows a sample prediction and label using imitation learning.

FIG. 9A shows a training process of dueling DQN agents with Epsilon-greedy exploration.

FIG. 9B shows a training process of dueling DQN agents using a guided exploration according to an embodiment of the present disclosure.

### DETAILED DESCRIPTION

The present disclosure relates to artificial intelligent (AI) based autonomous line flow control systems and methods. Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

In present disclosure, a novel system and method are introduced that adopts AI-based algorithms with several innovative techniques for training effective agents to provide fast and autonomous topology control strategies for maximizing time-series ATCs. The present disclosure is organized as follows: section I presents a problem formulation and introduces a principle of reinforcement learning (RL) for solving a Markov Decision Process (MDP). Section II provides a detailed architecture design, key steps, AI algorithms with several innovative techniques, and an implementation of the proposed methodology for autonomous topology control. Case studies are presented in section III to demonstrate the effectiveness of the proposed method.

Section I. Problem Formulation

A. Objectives, Control Measures, and Practical Constraints

The problem to solve in the present disclosure is discussed in the 2019 L2RPN challenge with full details in RTE France, ChaLearn, L2RPN Challenge. [Online]. Available: https://l2rpn.chalearn.org/). A main objective is to maximize the ATCs of a given power grid over all time steps of various scenarios. Each scenario is defined as operating the grid for a consecutive time period, e.g., four weeks with a fixed time interval of 5 minutes, considering daily load variations, pre-determined generation schedules and real-time adjustment, voltage setpoints of generator terminal buses, network maintenance schedules and contingencies. The control decisions only include network topology adjustment, namely, one node splitting/rejoining operation, one line switching, and the combination of these two. System generation and loads are not allowed to be controlled for enhancing the ATCs. Several hard constraints are considered for all the scenarios of interest: (a) system demands should be met at any time without load shedding; (b) no more than one power plant can be tripped; (c) no electrical islands can be formed as a result of topology control; (d) AC power flow should converge at all time. It will cause “game over” if any hard constraint is violated. For soft constraints, violations lead to certain consequences instead of immediate “game over”. Overloaded lines over 150% of their ratings are tripped immediately, which can be recovered after 50 minutes (10 time steps); while for overloaded lines below 150% of their ratings, control measures can be used to mitigate the overloading issue with a time limit of 10 minutes (2 time steps). If still overloaded, the line will be tripped, and cannot be recovered until after 50 minutes. In addition, a practical constraint is considered that is to allow a “cooldown time” (15 minutes) before a switched line or node can be reused for action. Both soft and hard constraints make the problem more practical and closer to real-world grid operation. To examine the performance of agents, metrics in Eq. (1) are used, which measure the time-series ATCs for a power grid.

$$step\_score = {\sum }_{i = 1}^{n \_ lines} max ( 0 , 1 - {( \frac{{lineflow}_{i}}{{thermallimit}_{i}} )}^{2} ) \\ chronic\_score = \{ \begin{matrix}0 & if gameover \\ {\sum }_{j = 1}^{n \_ steps} {step\_score}_{j} & otherwise\end{matrix} \\ total\_score = {\sum }_{k = 1}^{n \_ chronics} {chronic\_score}_{k} \qquad ( 1 )$$

The detailed mathematical formulation can be found in D. Shi, T. Lan, J. Duan, et al., “Learning to Run a Power Network through AI,” slides presentated at the 2019 PSERC Summer Workshop. [Online] Available: https://geirina.net/assets/pdf/2019-PSERC_L2RPN%20Presentation.pdf, which is incorporated in the present disclosure in its entirety.

B. Problem Formulated as MDP

Maximizing time-series ATCs via topology control or adjustment can be modeled as an MDP (R. S. Sutton, A. G. Barto, Introduction to reinforcement learning. MIT press Cambridge, vol. 2, no. 4, 1998), which consists of 5 key elements: a state space S, an action space [symbol] a transition matrix P, a reward function R, and a discount factor γ. In M. Lerousseau, A power network simulator with a Reinforcement Learning-focused usage. [Online]. Available: https://github.com/Marvi nLer/pypownet, an AC power flow simulator is used to represent the environment. The agent state (sₜ^{α}ϵS) is a partial observation from the environment state (sₜ^{e}ϵS). State sₜ^{α} contains 538 features, including active power outputs and voltage setpoints of generators, loads, line status, line flows, thermal limits, timestamps, etc. The action space [symbol] is formed by including line switching, node splitting/rejoining, and a combination set of both. An immediate reward rₜ at each time step is defined in Eq. (2) to assess the remaining available transfer capabilities:

$${r}_{t} = \{ \begin{matrix}- 1 & if game over \\ \frac{1}{N} {\sum }_{i = 1}^{N} max ( 0 , 1 - {( \frac{{lineflow}_{i}}{{thermallimit}_{i}} )}^{2} ) & otherwise\end{matrix} \qquad ( 2 )$$

In MDP, a cumulative future return Rₜ is defined which contains the immediate reward and the discounted future rewards, defined in Eq. (3):

Rₜ=rₜ+γrₜ₊₁+ . . . +γ^{T}r_{t+T}=Σₖ₌₀^{T}γ^{k}rₜ₊ₖ (3)

where T is the length of the MDP chain, and γϵ[0,1] is a discount factor.

C. Solving MDP Via Reinforcement Learning

With recent success in various control problems with high nonlinearity and stochastics, reinforcement learning is adopted which exhibits great potentials in maximizing long-term rewards for achieving a specific goal. See J. Duan, D. Shi, R. Diao, et al., “Deep-Reinforcement-Learning-Based Autonomous Voltage Control for Power Grid Operations,” IEEE trans. Power Syst., Early Access, 2019, and R. Diao, Z. Wang, D. Shi, et al., “Autonomous Voltage Control for Grid Operation Using Deep Reinforcement Learning,” IEEE PES General Meeting, Atlanta, Ga., USA, 2019. Various RL algorithms exist with pros and cons. One typical example is Q-learning, which utilizes a Q-table to map each state and action pair using an action-value, Q(s, α), which evaluates action a taken at state s by considering the future cumulative return Rₜ. According to the Bellman Equation (R. S. Sutton, A. G. Barto, Introduction to reinforcement learning. MIT press Cambridge, vol. 2, no. 4, 1998), the cumulative return can be represented as an expected return, shown in Eq. (4):

$$\begin{matrix}Q ( s , a ) = 𝔼 [ {R}_{t} \vert {S}_{t} = s , {A}_{t} = a ] \\ = 𝔼 [ {r}_{t} + γ Q ( {S}_{r + 1} , {A}_{t + 1} ) \vert {S}_{r} = s , {A}_{t} = a ]\end{matrix} \qquad ( 4 )$$

To obtain the optimal action-value Q*(s, α), Q-learning looks one step ahead after taking action a at state sₜ, and greedily considers the action aₜ₊₁ at state sₜ₊₁ for maximizing the expected target value rₜ+γQ*(sₜ₊₁, αₜ₊₁). Using the Bellman equation, the algorithm can perform online updates to control the Q-value towards the Q-target.

Q(sₜ,αₜ)←Q(sₜ,αₜ)+

$$α [ {r}_{t} + γ {max}_{{a}_{t + 1} ∈ 𝒜} Q ( {s}_{t + 1} , {a}_{t + 1} ) - Q ( {s}_{t} , {a}_{t} ) ] \qquad ( 5 )$$

where α represents the learning rate. Using a Q-table, both the state and action need to be discrete, thus making it difficult to handle complex problems. To overcome this issue, a deep Q network (DQN) method was developed which uses neural networks as a function approximator to estimate the Q-values, Q(s, α), so it can support continuous states in the RL process without discretization of states or building the Q-table. Weights θ of the neural network represent the mapping from states to Q-values, and therefore, a loss function Lᵢ(θ) is needed to update the weights and their corresponding Q-values, using Eq. (6) (See V. Mnih, K. Kavukcuoglu, D. Silver, et al., “Playing atari with deep reinforcement learning,” arXiv preprint arXiv:1312.5602, 2013):

Lᵢ(θᵢ)= [symbol] _{s,α˜ρ(·)}[(γᵢ−Q(s,α;θᵢ))²] (6)

where γᵢ= [symbol] _{s′˜ε}[r+γmax_{α′}Q(s′, α′; θᵢ₋₁)|s, α], and ρ is the probability distribution of the state and action pair (s, α). By differentiating the loss function using Eq. (7) and performing stochastic gradient descent, weights of the agent can be updated.

$${∇}_{{θ}_{i}} {L}_{i} ( {θ}_{i} ) = {𝔼}_{s , a \sim p ( \cdot ) ; {s}^{′} \sim ℰ} [ ( r + γ {max}_{{a}^{′}} Q ( {s}^{′} , {a}^{′} ; {θ}_{i - 1} ) - Q ( s , a ; {θ}_{i} ) ) {∇}_{{θ}_{i}} Q ( s , a ; {θ}_{i} ) ] \qquad ( 7 )$$

Given its advantages, DQN is selected as the fundamental DRL algorithm in embodiments of the present disclosure to train AI agents for providing topology control actions. However, overestimation is a well-known and long-standing problem for all Q-learning based algorithms. To address this issue, Double DQN (DDQN) that decouples the action selection and action evaluation using two separate neural networks is proposed in H. Van Hasselt, A. Guez, and D. Silver, “Deep reinforcement learning with double q-learning,” in 30th AAAI Conference on Artificial Intelligence, 2016. It demonstrates good performance in overcoming the overestimation problem and can obtain better results on ATARI 2600 games than other Q-learning based methods. In addition, a new model architecture, Dueling DQN is proposed in Z. Wang, T. Schaul, M. Hessel, et al., “Dueling network architectures for deep reinforcement learning,” arXiv preprint arXiv:1511.06581, 2015, which decouples a single-stream DDQN into a state-value stream and an action-advantage stream, and therefore, the Q-value can be represented as Eq. (8).

$$Q ( s , a ; θ , α , β ) = V ( s ; θ , β ) + ( A ( s , a ; θ , α ) - \frac{1}{\vert 𝒜 \vert} {\sum }_{{a}^{′}} A ( s , {a}^{′} ; θ , α ) ) \qquad ( 8 )$$

The stand-alone state value stream is updated at each step of training process. The frequently updated state-values and the biased advantage values allow better approximation of the Q-values, which is the key in value-based methods. It allows a more accurate and stable update for the agent. Thus, dueling DQN is selected as the baseline model in embodiments of the present disclosure to achieve good control performance.

Section II. Proposed Methodologies

A. Architecture Design

FIG. 1 shows a system architecture of training DRL agents for maximizing ATCs according to an embodiment of the present disclosure. In the DRL agent training system, first, an imitation learning 110 is used to generate a good initial policy from an environment 120 for the dueling DQN agent 130 so that exploration and training time can be greatly reduced; additionally, the dueling DQN agent 130 is less likely to fall into a local optimum. Second, a guided exploration method 140 is used to train the dueling DQN agent 130 instead of the traditional Epsilon-greedy exploration. Third, importance sampling 150 is used to increase the mini-batch update efficiency. Moreover, an Early Warning (EW) system 160 is designed to increase the system robustness. Details regarding these techniques are discussed in the following subsections.

B. Dueling DQN Agent

FIG. 2 illustrates an architecture of the dueling DQN agent 130 shown in FIG. 1. An original structure is adopted with a batch normalization layer added to the input layer 210, and a number of neurons 220 in a hidden layer is modified according to the dimensions of inputs and outputs. The dueling structure decouples the single stream into a state value stream 230 and an advantage stream 240, which are respectively processed by fully connected layers (FC) and then combined to feed into an output layer 250. The dueling DQN agent 130 also uses three important techniques in DQN, including: (1) an experience replay buffer that allows the agent to be trained off-policy and decouples the strong correlations between the consecutive training data; (2) importance sampling is used to increase the algorithm learning efficiency and final policy quality, by measuring importance of the data using absolute temporal difference (TD) error and giving important data higher priority to be sampled from memory buffer during the training process; and (3) adoption of a DDQN structure, which fixes the q-targets periodically, and then stabilizes the agent updates. The algorithm for training dueling DQN agents 130 is given in Algorithm 1.

Algorithm 1 Double Dueling DQN Guided Exploration Training Method

| | |
|---|---|
| 1: | Load pre-trained DQN weights: θ = θᵢₘᵢₜ. |
| 2: | Initialize Memory Buffer D to capacity N_{d}. |
| 3: | for episode ← 1, M do |
| 4: | Reset the environment, and obtain the state s₀ |
| 5: | for t ← 0, T do |
| 6: | Obtain Q(·\|st;θ) from the agent and obtain the set of actions with |
| | N_{g} largest Q values. |
| 7: | Validate and simulate the actions in the set and choose the valid |
| | action aₜ with best reward. |
| 8: | Execute action aₜ in the environment and observe next state sₜ₊₁, |
| | reward rₜ, and dₜ. |
| 9: | Store the experience (sₜ, aₜ, rₜ, sₜ₊₁, dₜ) in D, if dₜ is True, store |
| | multiple times. |
| 10: | Sample a minibatch of N_{b} experience (sₜ, aₜ, rₜ, sₜ₊₁, dₜ) from |
| | D using importance sampling. |
| 11: | Calculate q-targets: |
| | ${y}_{i} = \{ \begin{matrix}{r}_{i} & if {d}_{t} is True , \\ {r}_{i} + γ {max}_{{a}^{′}} Q ( {s}_{t + 1} , {a}^{′} \text{;} {θ}^{-} ) & otherwise\end{matrix}$ |
| 12: | Update main network using loss function every Nₛ step: |
| | Lᵢ(θ) = (yᵢ − Q(sₜ, aₜ;θ))² |
| 13: | Hard copy main network weights θ to the target network θ⁻. |
| 14: | Set state sₜ = sₜ₊₁. |
| 15: | end for |
| 16: | end for |

C. Imitation Learning

FIG. 3 shows a flowchart of the imitation learning 110 shown in FIG. 1. The imitation learning 110 is essentially a supervised learning method that is used to pre-train DRL agents by providing good initial policies in the form of neural network weights. In step 310, a power grid simulator uses an virtual environment to generate massive data sets, which are then further processed in step 320 before being used to train a DDQN agent in step 330. The processing step 320 includes filtering qualified data and normalizing the data. In the training step 330, the DDQN agent is trained with the aforeprepared data using imitation learning method. Then initial weights of the DDQN is outputted for future DRL traing. The training step 330 selects the best imitation learning model with the minimum loss.

The imitation learning process 110 allows the DRL agent to obtain good Q(s, α) distributions regarding different input states. The loss function used to train the agent is defined as weighted Mean-Squared-Error (MSE), in Eq. (9):

$${J}_{θ} = α \times \frac{1}{N} {\sum }_{i = 1}^{N} {( Q ( s , {a}_{i} ) - \hat{Q} ( s , {a}_{i} ) )}^{2} + β \times \frac{1}{\vert 𝒜 \vert - N} {\sum }_{i = N + 1}^{\vert 𝒜 \vert} {( Q ( s , {a}_{i} ) - \hat{Q} ( s , {a}_{i} ) )}^{2} \qquad ( 9 )$$

where α, βϵ[0, 1], α+β=1, | [symbol] | is the size of action space, and vector Q(s, α)=[Q(s, αᵢ), i=1, . . . , | [symbol] |] is sorted in descending order. The loss function J_{θ} gives a higher weight to actions resulting in high scores, which makes the agent more sensitive to score peaks during the training process, and therefore helps the agent better extract good actions.

D. Guided Exploration Training Method

The imitation learning 110 shown in FIG. 1 provides a good initial policy for snapshots, and then DRL is used to train the agent for long-term planning capability and to obtain a globally-concerned policy. For DRL training in this problem, the traditional Epsilon-greedy exploration method is inefficient. First, the action space is pretty large and the MDP chain is long. Second, the agent is easy to fall into a local optimum. Thus, the guided exploration 140 method is developed, where actions with the N_{g} highest Q-values are selected at every timestep, the performance of which are simulated and evaluated on the fly. Then, the action with the highest reward is chosen for implementation and such experience will be stored in the memory. The guided exploration 140 helps the DRL agent to further extract good actions. With the help of an action simulation function, the training process is more stable, and a better experience is stored and used to update the agent. Thus, the guided-exploration 140 significantly increases the training efficiency.

E. Early Warning

Power systems are highly sensitive to various operating conditions, especially with major topology changes. One bad action may have a long-term adverse effect since the system topology control is successive in a long period of time. The trained DRL agent is not guaranteed to provide a good action every time at various complex system states. Thus, an adaptive mechanism, named Early Warning 160 shown in FIG. 1, is developed in an embodiment of the present disclosure which can help the DRL agent determine when to apply action and simulate more actions with high Q (s, α) values to increase the error-tolerance and enhance system robustness.

FIG. 4 shows a workflow of the early warning (EW) system 160 shown in FIG. 1. Initially, at every timestep, the EW system 160 simulates the result of taking no action to the environment in step 410, using a warning flag (WF) defined in Eq. (10).

$$WF = \{ \begin{matrix}True & if \frac{{lineflow}_{i}}{{thermallimit}_{i}} > λ , ∀ i ∈ \{ 1 , 2 , … , 20 \} \\ False & otherwise\end{matrix} \qquad ( 10 )$$

The EW system 160 detects the warning flag in step 420, which includes at a time step t, using a forecast data at time step t+1 to determine whether the power flow, e.g., a loading level of a line, will be over a predetermined threshold λ. The forecast data may be derived from historical data based on the current data. If the loading level of a line is higher than the threshold λ, a WF is raised. As a result, the N_{g} top-scored actions are provided by the agent for further simulation in step 430. Consequently, the best action with the highest reward without overflow will be taken and outputted in steps 440. In step 420, if the loading level of a line is lower than the pre-determined threshold k, the EW system 160 takes “do nothing action” in step 460 and proceed to repeat the above process flow for a next timestep in step 450. Both the guided exploration 140 and the early warning mechanism 160 improve the performance and robustness of the proposed RL algorithm.

FIG. 5 shows a flowchart of an exemplary process for maximizing time-series ATCs according to an embodiment of the present disclosure. The exemplary process begins with the imitation learning step 110 shown in FIG. 1 and FIG. 3, in which an imitation learning is performed to obtain the initial weights for a DRL agent. In step 510, an electric power system's state exemplarily measured by phasor measurement units (PMU) and/or a supervisory control and data acquisition (SCADA) system at a particular time step are inputted into the process. Then the above described early warning system 160 is used to determine whether the DRL agent needs to be activated based on the early warning flag signal. In response to a warning flag, the process generates an action by the DRL agent in step 520 using a DRL algorithm. An exemplary DRL algorithm is described in above Algorithm 1. The step 520 also includes analyzing the next state and reward, restore the information in a replay buffer for future use as detailed in FIG. 6. In step 530, the generated action is executed in the electric power system to maximize the ATCs. Then the process moves to a next time step and repeats itself.

FIG. 6 shows a flowchart of a DRL training process 600 used for step 520 shown in FIG. 5. The DRL training process 600 begins with DRL agent training initialization and power flow initialization in step 610. The DRL agent training initialization includes initialize DRL agent information and restore imitation model for DRL initial weights. The power flow initialization includes reset power grid environment and reload time-sequential training data for a predetermined period. In step 620, when a warning flag is raised in a zone of the electric power system, a DRL agent for the zone will be activated to generate suggested control actions. In step 630, the suggested control actions are executed in a power grid simulator and their effectiveness is evaluated with a predefined reward function based on the ATCs and training event information. In step 640, the training process 600 restores transition information into a replay buffer of each DRL agent. In step 650, progress of the current episode is inspected. If the current episode is not finished, the training process 600 goes to step 652, where the replay buffer is sampled and provided to step 655 for updating the DRL agent. After moving to next time step data in step 658, the training process 600 returns to step 620. If the current episode is finished in step 650, the training process 600 records current episode composition information in step 660. If at this time step all the episodes are finished in step 670, the training process 600 outputs a trained DRL model in step 680. If all the episodes are not finished, the training process 600 returns to step 610's power flow initialization with an environment reset.

FIG. 7 illustrates an electric power system having an AI-based autonomous topology control according to an embodiment of the present disclosure. States of an electric power grid 702 are extracted by measure systems such as PMUs and an ACADA. The measure states at a series of time steps are fed to an AI-based autonomous to topology control system 720 which uses imitation learning and DRL training as depicted in FIG. 1 through FIG. 6 to generate control actions. In the control action generating process, the autonomous topology control system may use a power system simulator to analysis a new state in response to a certain control action. A power system control system 730 takes in the generated control actions and perform topology control to achieve ATC maximization and power loss minimization for the electric power grid 702. The topology control action may include transmission line switching or bus splitting.

The AI-based autonomous topology control system 720 shown in FIG. 7 and method of the embodiment of the present disclosure may include software instructions including computer executable code located within a memory device that is operable in conjunction with appropriate hardware such as a processor and interface devices to implement the programmed instructions. The programmed instructions may, for instance, include one or more logical blocks of computer instructions, which may be organized as a routine, program, library, object, component and data structure, etc., that performs one or more tasks or performs desired data transformations. In an embodiment, generator bus voltage magnitude is chosen to maintain acceptable voltage profiles.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In certain embodiments, a particular software module or component may comprise disparate instructions stored in different locations of a memory device, which together implement the described functionality of the module. Indeed, a module or component may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, Software modules or components may be located in local and/or remote memory storage devices. In addition, data being tied or rendered together in a database record may be resident in the same memory device, or across several memory devices, and may be linked together in fields of a record in a database across a network.

Section III. Case Studies

A. Environment and Framework

A power grid simulator, Python Power Network (Pypownet) (M. Lerousseau, A power network simulator with a Reinforcement Learning-focused usage. [Online]. Available: https://github.com/Marvi nLer/pypownet), is adopted to represent the environment for training RL agents, which is built upon the MATPOWER open-source tool for power grid simulations. It is able to emulate a large-scale power grid with various operating conditions that supports both AC and DC power flow solutions. The framework is developed in Linux, with an interface designed and provided for Reinforcement Learning. The RL agents are trained and tuned using python scripts through massive interactions with Pypowernet. Besides, a visualization module is provided for the users to visualize the system operating status and evaluate control actions in real-time. Several power system models have been provided in this framework with datasets representing realistic time-series operating conditions. The dataset for the IEEE 14-bus model contains 1,000 scenarios with data for 28 continuous days. Each scenario has 8,065 time steps, each representing a 5-minute interval. All models and associated datasets can be directly downloaded from RTE France, ChaLearn, L2RPN Challenge. [Online]. Available: https://l2rpn.chalearn.org/.

With the developed environment and framework, the IEEE 14-bus system with the supporting dataset is used to test performance of the proposed DRL agents in autonomous network topology control over long time-series scenarios. In this system, there are a total of 156 different node splitting actions and 20 line switching actions. Thus, an action space of 3,120 is formed by considering null action and all combinations of one node splitting and one line switching without those that can create islands. The DRL agents are trained using Python 3.6 scripts on a Linux server with 48 CPU cores and 128 GB of memory.

B. Effectiveness of Imitation Learning for Generating Good Initial Policies

In the first test, a brute-force method is used to train the agent using randomly initialized neural network weights and the full action space with a dimension of 3,120. As expected, due to the large action space and the long time-sequences, the proposed dueling DQN method didn't work well. To solve this problem, the following process is employed to effectively reduce the action space, which includes: (1) 155 node splitting/rejoining actions, (2) 19 line switching actions, and (3) 76 most effective actions with one bus action and one line switching action, and one do-nothing action. In this way, the action space A is reduced to 251. Then, the imitation learning method introduced in Section III. C is used to obtain good initial policies. Forty scenarios, each with 1,000 timesteps (instead of 8,065), are used for imitation learning, yielding a total number of 40,000 sample pairs, (state, Q(s, α)), which are then separated into a training set (90%) and a validation set (10%).

FIG. 8 shows a sample prediction and label using imitation learning (IL). After training 100 epochs with a batch size of 1, the weighted MSE decreased to around 0.05, indicating neural networks can generally catch the peaks and trends, and provide relatively effective actions.

C. Improved Training Performance with Guided Exploration

To shorten the MDP chain and decrease the training difficulty, the 28-day scenarios are divided into single days, each with 288 timesteps. For comparison, the training process of dueling DQN agents with Epsilon-greedy exploration is shown in FIG. 9A and the proposed guided exploration are plotted in FIG. 9B.

With Epsilon-greedy exploration, the agent can hardly control the entire 288 timesteps continuously before Episode 7,000, without game over, although the agent's performance keeps improving towards higher reward values (defined in Eq. (2)). The proposed training process using guided exploration with N_{g}=10 is shown in FIG. 9B. The agent can control more steps successfully in the earlier phases of the training process compared to Epsilon-greedy exploration. More importantly, it takes a much shorter time to train an agent with a better policy.

D. Testing and Performance Comparison of Different Agents

With the proposed methodology, several case studies are conducted with their performance compared in TABLE I.

TABLE I
Performance comparison of different agents on 200 unseen scenarios
with 288 time steps

| | | | Mean Score |
|---|---|---|---|
| Agent | Game Over | Mean Score All | w/o Dead |
| Do Nothing | 91 | 2471.42 | 4534.72 |
| Only imitation | 198 | 382.1 | 3820.63 |
| Guided Trained | 7 | 4260.63 | 4424.49 |
| EW λ = 0.85 | 0 | 4253.40 | 4253.40 |
| EW λ = 0.875 | 1 | 4347.56 | 4369.41 |
| EW λ = 0.90 | 0 | 4396.77 | 4396.77 |
| EW λ = 0.925 | 0 | 4493.27 | 4493.27 |
| EW λ = 0.95 | 0 | 4492.89 | 4492.89 |
| EW λ = 0.975 | 2 | 4446.12 | 4491.03 |

It is observed that the agent trained only with IL failed for most scenarios. With guided exploration, the agent's performance is greatly improved, where only 7 out of 200 scenarios failed. Using EW (with threshold λ, ranging from 0.85 to 0.975), the agent can almost handle all the scenarios well with very few cases failed; and the scores are much improved. Similarly, 200 long scenarios with 5,184 time steps are tested using DRL agents, where the best score achieved is 82,687.17, using an EW threshold of 0.93. Only 12 scenarios out of 200 experienced bad control performance. Finally, a well-trained agent was submitted to the L2RPN competition with EW λ=0.885, which was automatically tested using 10 unseen scenarios by the host of the competition, outperformed the other participants, and eventually won the competition. The average decision time for each time step using the proposed agent is roughly 50 ms. The corresponding code and DRL models are open-sourced, which can be found in GEIRINA, CodaLab L2RPN: Learning to Run a Power Network. [Online]. Available: https://github.com/shidi1985/L2RPN.

The embodiments of the present disclosure were used to participate in the 2019 L2RPN, a global power system AI competition hosted by RTE France and ChaLearn, considering full AC power flow and practical constraints, which eventually outperformed all competitors' algorithms.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

What is claimed is:

1. A method for autonomous line flow control in an electric power system, the method comprising:
acquiring state information at a line in the electric power system at a first time step;
obtaining a flow data of the line at a next time step based on the acquired state information;
generating an early warning signal when the obtained flow data is higher than a predetermined threshold;
activating a deep reinforcement learning (DRL) agent to generate an action using a DRL algorithm based on the state information; and
executing the action to adjust a topology of the electric power system.

2. The method of claim 1, wherein the state information are acquired by a phasor measurement unit (PMU) or a supervisory control and data acquisition (SCADA) system coupled to the line.

3. The method of claim 1, wherein the state information is a loading level of the line.

4. The method of claim 1, wherein the DRL agent upon being activated simulates a predetermined number of top-scored actions and takes an action with the highest simulated score for the execution.

5. The method of claim 1 further comprising training the DRL agent prior to controlling the line flow in the electric power system.

6. The method of claim 5, wherein the DRL agent training includes a dueling deep Q network (DDQN).

7. The method of claim 6, wherein the DDQN includes training the DRL agent to decouple strong correlations between consecutive training data by using an experience replay buffer.

8. The method of claim 6, wherein the DDQN includes measuring importance of data using temporal difference (TD) error and giving important data higher priority to be sampled from a memory buffer during the DRL training process.

9. The method of claim 6, wherein the DRL agent training includes providing initial weights to the DRL agent with an imitation learning process.

10. The method of claim 9, wherein the imitation learning process includes
generating massive data sets from a virtual environment by a power grid simulator; and
training the DRL agent using mini-batch data from the data sets with an imitation learning method.

11. The method of claim 5, wherein the DRL agent training includes:
initializing the DRL agent with initial weights;
loading time-sequential training data for a predetermined period;
generating a suggested action for a zone when an early warning signal for the zone is generated;
executing the suggested action in a power grid simulator;
evaluating effectiveness of the suggested action with a predefined reward function; and
restoring transition information from the DRL agent training into a replay buffer of the DRL agent.

12. The method of claim 11, wherein the DRL agent training further includes:
updating the DRL agent by sampling from the replay buffer after a training episode;
recording current episode composition information; and
outputting a trained DRL model after a predetermined number of episodes are finished.

13. The method of claim 1, wherein the adjusting topology includes transmission line switching or bus splitting.

14. A system for autonomous line flow control in an electric power system, the system comprising:
measurement devices coupled to lines of the electric power system for measuring state information at the lines;
a processor; and
a computer-readable storage medium, comprising:
software instructions executable on the processor to perform operations, including:
acquiring state information at a line in the electric power system at a first time step;
obtaining a flow data of the line at a next time step based on the acquired state information;
generating an early warning signal when the obtained flow data is higher than a predetermined threshold;
activating a deep reinforcement learning (DRL) agent to generate an action using a DRL algorithm based on the state information; and
executing the action to adjust a topology of the electric power system.

15. The system of claim 14, wherein the state information are acquired by a phasor measurement unit (PMU) or a supervisory control and data acquisition (SCADA) system coupled to the line.

16. The system of claim 14, wherein the state information is a loading level of the line.

17. The system of claim 14, wherein the DRL agent upon being activated simulates a predetermined number of top-scored actions and takes an action with the highest simulated score for the execution.

18. The system of claim 14 further comprising training the DRL agent prior to controlling the line flow in the electric power system.

19. The system of claim 18, wherein the DRL agent training includes a dueling deep Q network (DDQN).

20. The system of claim 19, wherein the DDQN includes training the DRL agent to decouple strong correlations between consecutive training data by using an experience replay buffer.

21. The system of claim 19, wherein the DDQN includes measuring importance of data using temporal difference (TD) error and giving important data higher priority to be sampled from a memory buffer during the DRL training process.

22. The system of claim 19, wherein the DRL agent training includes providing initial weights to the DRL agent with an imitation learning process.

23. The system of claim 22, wherein the imitation learning process includes
generating massive data sets from a virtual environment by a power grid simulator; and
training the DRL agent using mini-batch data from the data sets with an imitation learning method.

24. The system of claim 18, wherein the DRL agent training includes:
initializing the DRL agent with initial weights;
loading time-sequential training data for a predetermined period;
generating a suggested action for a zone when an early warning signal for the zone is generated;
executing the suggested action in a power grid simulator;
evaluating effectiveness of the suggested action with a predefined reward function; and
restoring transition information from the DRL agent training into a replay buffer of the DRL agent.

25. The system of claim 24, wherein the DRL agent training further includes:
updating the DRL agent by sampling from the replay buffer after a training episode;
recording current episode composition information; and
outputting a trained DRL model after a predetermined number of episodes are finished.

26. The system of claim 14, wherein the adjusting topology includes transmission line switching or bus splitting.

27. A method for autonomous line flow control in an electric power system, the method comprising:
acquiring loading level at a line in the electric power system at a first time step;
obtaining a flow data of the line at a next time step based on the acquired loading level;
generating an early warning signal when the obtained flow data is higher than a predetermined threshold;
activating a deep reinforcement learning (DRL) agent to simulate a predetermined number of top-scored actions based on the state information;
selecting an action with the highest simulated score using a DRL algorithm; and
executing the selected action to adjust a topology of the electric power system.

28. The method of claim 27 further comprising training the DRL agent using a dueling deep Q network (DDQN) prior to controlling the line flow in the electric power system.

29. The method of claim 28, wherein the DRL agent training includes providing initial weights to the DRL agent with an imitation learning process, the imitation learning process comprising:
generating massive data sets from a virtual environment by a power grid simulator;
training the DRL agent using mini-batch data from the data sets with an imitation learning method.

30. The method of claim 28, wherein the DRL agent training includes:
initializing the DRL agent with initial weights;
loading time-sequential training data for a predetermined period;
generating a suggested action for a zone when an early warning signal for the zone is generated;
executing the suggested action in a power grid simulator;
evaluating effectiveness of the suggested action with a predefined reward function;
restoring transition information from the DRL agent training into a replay buffer of the DRL agent;
updating the DRL agent by sampling from the replay buffer after a training episode;
recording current episode composition information; and
outputting a trained DRL model after a predetermined number of episodes are finished.
